(19) United States
(12) Patent Application Publication
(10) Pub. No.: US 2004/0221452 A1
(43) Pub. Date: Nov. 11, 2004

(54) Method for the manufacture of a piston

(75) Inventors: Peter Wirth, Schonungen (DE); Gerald Fenn, Pfersdorf (DE); Hassan Asadi, Schweinfurt (DE)

Correspondence Address: COHEN, PONTANI, LIEBERMAN & PAVANE, 551 FIFTH AVENUE, SUITE 1210, NEW YORK, NY, 10176, US

(73) Assignee: ZF Sachs AG

(21) Appl. No.: 10/840,035

(22) Filed: May 6, 2004

(30) Foreign Application Priority Data
May 7, 2003 (DE) 103 20 208.0

(51) Int. Cl. B23P 15/10

(52) U.S. Cl. 29/888.04

(57) ABSTRACT

Method for the manufacture of a piston, wherein the piston comprises a piston body with through-channels for fluid which are covered by valve disks on support bodies with valve support surfaces, wherein the piston body is disk-shaped and is constructed in one piece by means of press stamping and, starting from a base body of the piston, the support bodies which are raised on one side of the piston are formed as recesses on the axially opposite side of the piston, and the piston has at least one support for the valve disks which is likewise pressed out of the piston base body on both sides of the piston, wherein the support of the piston body is formed from the piston body in a die tool by material flow against the pressing movement of a forming tool.

### BACKGROUND OF THE INVENTION

1. Field of the Invention

The invention is directed to a method for the manufacture of a piston including a disk-shaped base body having opposed sides, through-channels between the sides, and a support raised above one of the sides for supporting a valve disk, each through-channel being surrounded by a support body raised above one side for supporting a valve disk, and a recess recessed below the opposite side.

2. Description of the Related Art

U.S. Pat. No. 6,018,868 discloses a piston which is produced by press stamping. Raised valve support surfaces and central supports for valve disks extend on both sides proceeding from a piston base body. Both the support and the valve support surface are stamped out from the piston base body by alternating stamping. As shown in FIG. 3 of this patent in the area of the narrow segment 37, the volume proportion that can be shaped sets limits on the size of the support in circumferential direction, but also with respect to the outer diameter. For a precise adjustment of damping force, the underside of a valve disk lying on the support must be supported on a diameter equal in size to or, better, larger in size than the outer diameter of a clamping washer or clamping nut on the upper side of the valve disk. A faulty support of the valve disk at the underside can lead to a divergence in damping force which must be determined in a time-consuming manner in the course of manufacture and scrapped.

Alternatively, the support can also be produced by a separate support ring which is pressed into a pocket hole opening of the piston. However, it has been shown that when the valve disks are clamped on the piston a support ring that has been pressed in undergoes a very slight settling which can sometimes increase appreciably at the edge of the valve disks and generate very small leaks which negatively affect the piston valve, particularly with damping force adjustments tending toward the harder side.

### SUMMARY OF THE INVENTION

It is the object of the present invention to further develop a piston that can be produced by press stamping such that the problem of supports for the valve disk is at least reduced.

According to the invention, this object is met in that the support of the piston body is formed from the piston body in a die tool by material flow against the pressing movement of a forming tool.

The great advantage over the prior art is in that an appreciably larger support, i.e., in particular, with a larger outer diameter, can be achieved by the flow of volume out of the piston blank. The two main problems of the prior art are accordingly eliminated. On the one hand, the support in its entirety is appreciably larger so that the valve disks can be pretensioned better and the support is integral with the piston base body, so that the disadvantages of a pressed in support ring are avoided. The flow constitutes a cold hardening of the piston so that the settling effect which formerly took place in the support is minimized.

Accordingly, a stamp is pressed in the area of a through-opening which is to be produced and which is enclosed by the support, and the displacement volume of the stamp in the piston body flows into the area of the support. Formerly, the through-opening, if any, was completely punched out. The punched volume represents waste. With this production step, volume which was previously forfeited is now used.

The diameter of the stamp is smaller than the provided through-opening. Accordingly, there remains a residual volume which guarantees a final through-punching combined with a high-quality surface and, above all, dimensional accuracy with respect to shape and position.

Supports for the valve disks are produced on both sides. A stamp is pressed into the piston body synchronously from both sides for a deliberate material flow.

A further possibility consists in that a stamping blank for the piston base body has a greater material thickness than the piston base body in the final state, wherein the differential volume caused by upsetting determines the support by material flow. The supports do not require an especially great height in relation to the piston base body. For example, when the stamping blank is selected 1 mm thicker than the total height of the piston and the piston base body is then upset by 0.5 mm on both sides, a support has then already been achieved on both sides.

It can be provided in addition that the occurring differential volume between the stamping blank and the piston base body in the final state flows to the support. The diameter and/or the height of the support can accordingly be increased.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows an example of the use of the piston in a vibration damper;

FIG. 2 is a top view of the piston; and

FIG. 3 shows the piston in die halves.

### DETAILED DESCRIPTION OF THE PRESENTLY PREFERRED EMBODIMENTS

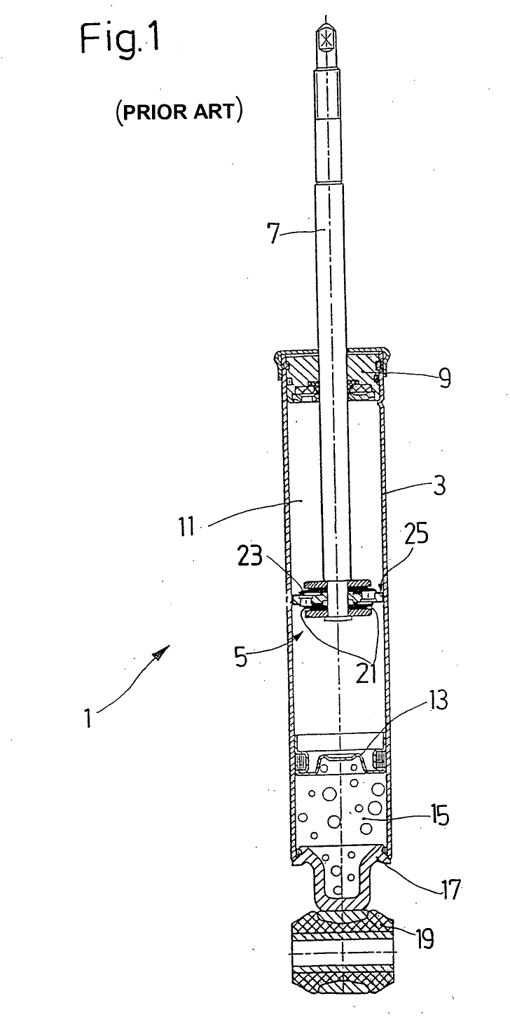

FIG. 1 shows, by way of example, a piston-cylinder unit 1 constructed as a single-tube vibration damper. In principle, the invention can also be applied in other piston-cylinder units.

The single-tube vibration damper 1 substantially comprises a pressure tube 3 in which a piston 5 is arranged at a piston rod 7 so as to be movable axially. At the outlet side of the piston rod 7, a piston rod guide 9 closes a work space 11 which is filled with damping medium and which is separated by a dividing piston 13 from a gas space 15 having a base 17 with a lug 19 at the end.

During a movement of the piston rod, damping medium is forced through damping valves 21 in the piston 15 which are formed by valve disks 23. A piston ring 25 which covers a circumferential surface of the piston 5 prevents damping medium from flowing around the sides of the piston and takes over the reduced-friction guidance of the piston.

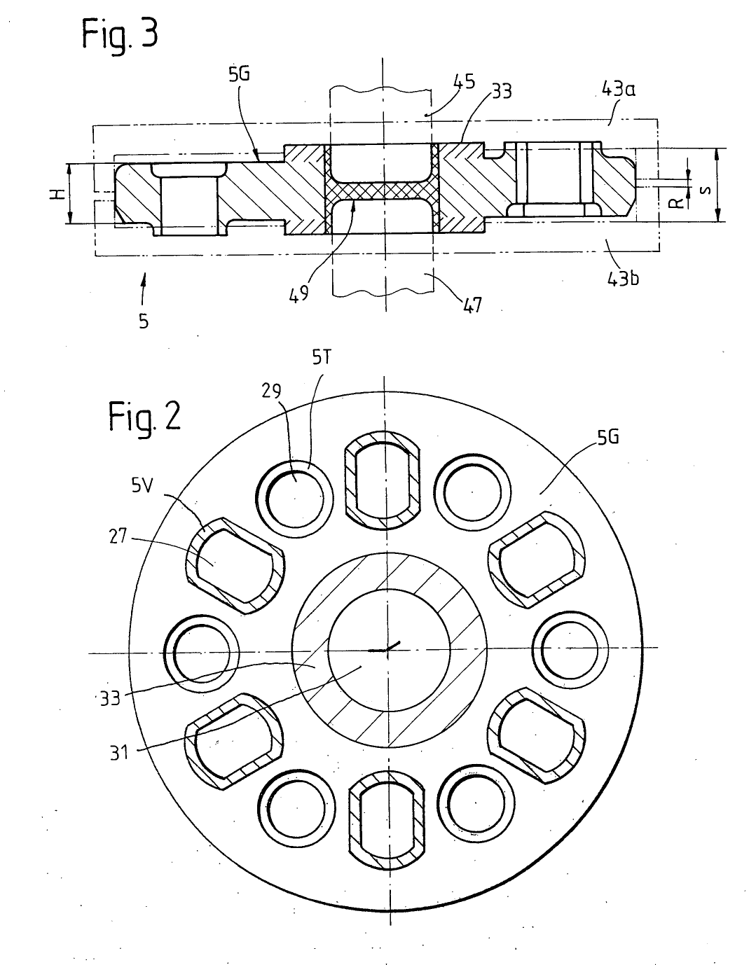

FIG. 2 shows a top view of the piston 5 in the finished state. Proceeding from a piston base body 5G, raised valve support surfaces 5V, indicated by shading, extend around through-channels 27, 29. The valve disks 23 are clamped on the valve support surfaces 5V. The valve support surfaces 5V which are raised on one side of the piston are constructed on the other side so as to have the same volume as recess 5T. Circular supports 33 are formed in one piece from the piston body on both sides around a central through-opening 31 for the piston rod 7.

The piston 5 is produced by a press stamping process. The piston body can also be free-hand cut completely from a material strip and this comparatively small structural component part must then be guided separately through the rest of the pressing process steps, or the piston base body is cut out in a final stamping step only after the surface contour of the piston has been finished. However, in this procedure, it can not be entirely ruled out that an adjacent piston will be formed along with the piston through the pressing and stamping steps, even to a slight extent. Both of the problems described above are avoided by free-hand cutting of the piston base body in the manner described above.

An axially divided die tool 43a; 43b used for the production of the circular support 33 is shown in FIG. 3 by dash-dot lines. The die tool has the negative contour of the piston base body and its two supports 33 for the valve disks for damping valves on both sides. In general, there are two variants of the method, according to the invention, for forming the supports 33 through a pressing movement of a forming die and a material flow from the piston base body against the pressing movement. The two method variants can also be used in combination.

In a particularly economical procedure, a stamping blank whose material thickness corresponds to the height H of the piston base body 5G is used. In this case, the two die tool halves 43a; 43b lie on one another so as to be closed at their outer edges. An opening is constructed in both die tool halves and a stamp 45, 47 can be pressed through the opening axially into the piston base body. The displacement volume caused by the stamps in the area of the yet-to-be-produced through-opening 31 for the piston rod flows into the area of the support 33. The die tool halves define the contour of the upper side and the diameter of the support 33. This flow behavior is illustrated by different shading between the piston base body 5G and the support 33. When a stamp 45, 47 is pressed into the piston base body from both sides, a residual cross section 49 which hardens very strongly occurs between the stamps and is no longer available for further material flow at a reasonable expenditure. This residual cross section between the end faces of the stamps is indicated by cross-hatching.

Another residual cross section occurs in that the diameter of the stamps 45, 47 is smaller than the provided through-opening 31. When the supports 33 are made by the material flow, the entire residual cross section 49 is stamped out at the nominal diameter for the through-opening of the piston rod.

In an alternate variant, the stamping blank for the piston base body has a greater material thickness R than the piston base body 5G in the final state. In this procedure, the supports 33 can be produced in a simple manner by an axial upsetting movement of the die tool halves by a measurement s in that the residual surface of the piston base body 5G is simply reduced compared to the provided support 33 by upsetting the stamping blank. The required height difference between the support and the piston base body is not very large. The surplus volume is then displaced outward and removed from the stamping blank by the subsequent punching of the piston. However, it is certainly more sensible when the differential volume occurring between the stamping blank and the finished piston base body due to the axial upsetting movement of the die tool halves has flowed to the support 33 in the final state. For this purpose, the die tool halves 43a; 43b enclose the piston base body about the circumferential surface of the piston except to the extent indicated by s. When this method is used, the material flow can still possibly be utilized in addition through the use of the stamps depending on the geometry of the piston body to be produced.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for manufacturing a piston comprising a disk-shaped base body having opposed sides, through-channels between the sides, and a support raised above one of the sides for supporting a valve disk, each said through-channel being surrounded by a support body raised above one side for supporting a valve disk, and a recess recessed below the opposite side, said method comprising:
receiving said base body between a pair of die tool halves, and
pressing a forming tool into one of the body to form said support by material flow.

2. A method as in claim 1 further comprising removing material within said support to provide a through-opening.

3. A method as in claim 2 wherein the diameter of the forming tool is smaller than the diameter of the through-opening.

4. A method as in claim 1 comprising pressing a pair of forming tools into respective opposed sides of said base body synchronously to form a pair of said opposed supports on respective opposed sides of said base body by material flow.

5. A method as in claim 1 wherein said tool die halves comprise said forming tool, said method comprising:
providing a stamping blank for said base body, said stamping blank having a greater thickness than said base body after pressing said forming die therein; and
forming said support by upsetting said tool die halves so that the forming tool is pressed into said one of said sides.

6. A method as in claim 5 wherein the differential volume between the stamping blank and the base body after pressing said forming die therein flows into said support.
